(19) United States
(12) Patent Application Publication
(10) Pub. No.: US 2003/0093302 A1
(43) Pub. Date: May 15, 2003

(54) Method and system for online binding of insurance policies

(76) Inventors: Francis Quido, North Branford, CT (US); David Spar, Pearl River, NY (US); James Kim, Bayside, NY (US); Vadim Brodsky, Brooklyn, NY (US); Jitendre Patel, Patel, NJ (US); Anatoly Aminoz, Kew Gardens, NY (US)

Correspondence Address: William J. Sapone, Esq., Coleman Sudol Sapone P.C., 714 Colorado Avenue, Bridgeport, CT, 06605, US

(21) Appl. No.: 09/971,787

(22) Filed: Oct. 4, 2001

Related U.S. Application Data
(60) Provisional application No. 60/238,089, filed on Oct. 4, 2000.

(51) Int. Cl. G06F 17/60

(52) U.S. Cl. 705/4

(57) ABSTRACT

A method and system for online binding of insurance policies uses a data processing system to collect information from a user who is seeking a policy, issues queries to various databases to collect information on insurability in real time, weighs and analyzes the information and rates the user as to acceptability, and if acceptable, proceeds upon acceptance by the user, to bind the policy. The system sets premiums, determines payment methods and schedules and enables immediate printing of insurance documents such as insurance identification cards.

### RELATED APPLICATIONS

This application claims priority in U.S. Provisional Patent Application No. 60/238,089 filed Oct. 4, 2000.

### TECHNICAL FIELD

This invention relates to data processing systems and more particularly to a data processing system accessible online via the Internet and having means for automatically qualifying applicants for issuance of insurance policies, and for binding such policies, on-line.

### BACKGROUND

It is known in the insurance industry for a representative to create an insurance agreement or policy based on information obtained from a prospective insured. An insurance rate is calculated based on the information provided by the applicant relative to the coverage sought. Generally, while a non-binding quotation may be obtained in a relatively short time frame based on the information provided, it is typically necessary to validate the information provided before a policy can actually be issued and because of the investigation required, it has not been possible to bind an insurance policy without delays of days to weeks.

### SUMMARY OF THE INVENTION

It is an object of the present invention to provide a method of automatic, real-time binding of insurance policies to qualified applicants on line.

It is another object to provide a system using data processing means and communication means to provide automatic verification of information provided by the applicant to evaluate the insurability of an applicant.

It is a further object to provide a system which provides automatic online binding of insurance policies after computer verification and analysis of the information.

These and other objects of the present invention are achieved by a method comprising providing a data-processing system having means to communicate and query a plurality of databases; providing a user-interface accessible via the Internet, the interface connected to the data processing system; querying the user for information related to insurability via the interface, the information received by the data processing system; analyzing and issuing queries to select databases for verification and supplementation of the user information; comparing the user information to the retrieved information from the databases, weighing the information as to risk and determining whether the user is qualified to be insured such that the data processing system then advises the user if the user is accepted, allowing the user to agree to accept a policy, and if accepted, generating a binding insurance agreement. If the user is not qualified automatically, the data processing system refers the user to a representative for further inquiry.

Using a data processing system in real time communication with various databases such a those containing motor vehicle records, credit records, etc., a real time assessment can be made of the qualification of the applicant for insurance. Based on the information provided, compared and/or supplemented by information received from the selected databases, an analysis of risk is determined by the data processing system such that the applicant may be accepted and a binding insurance agreement issued immediately upon confirmation of his qualifications and upon agreement to pay the premium. In a preferred embodiment, the data processing system generates the premium required based on the analysis, and therefore the entire process can be automated, allowing for insurance to be obtained in real time 24 hours per day/7 days a week. Where the applicant is deemed to lack the proper qualifications, for whatever reason, the applicant is automatically referred to a representative, who may seek additional information or offer alternative coverage. Use of such a system will significantly reduce the time required to bind an insurance agreement and reduce the costs associated with providing insurance.

### BRIEF DESCRIPTION OF DRAWINGS

FIG. 1 is a view of the proposed architecture for the system of the present invention.

FIGS. 2a-2e is a high-level flow chart which depicts the sequence of steps associated with the creation of a binding insurance agreement using the data processing system in accordance with the present invention.

FIG. 3 is a view of the system architecture.

### DETAILED DESCRIPTION OF THE INVENTION

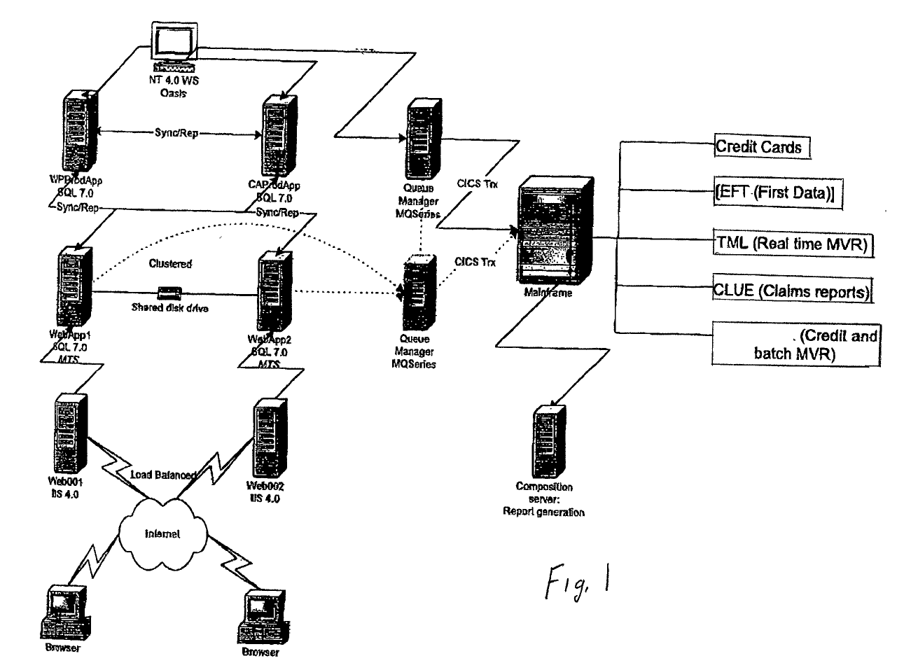

With reference to FIG. 1, a data processing system utilizes a server for communication with a plurality of users via the Internet. The data processing system has incorporated therein an online policy binding application, a communication interface, for communication with a plurality of remote databases via internet, intranet direct modem or ISDN link or other means, data storage capability sufficient to maintain internal databases and related information retrieved and to save data received from applicants as well as information related to the various policies that may be offered through the system.

The online binding application is a web application that provides a user interface and all functionality to enable an applicant to bind a policy online. The application includes logic that enable analysis and evaluation of the information provided by a user so as to determine whether a policy should be issued and optionally further derives the premium related to the degree of risk associated with the user.

The information is collected from the user first typically via a quotation process, where information is collected and sorted in the server database which also maintains additional data required to support both the quoting and binding process. While the quotation process itself has been known and used, the ability to bind an insurance application on line has not been available previously and consequently the following description will, while describing both the quoting and binding processes as they are interrelated, relate more specifically to the binding process which is the subject of the applicant's invention.

The communication interface allows access by the data processing system to local and remote sources of information, as required, for obtaining, for example, motor vehicle reports, comprehensive loss underwriting exchange reports, credit reports, title records, etc and information related to payment processing, for example, if done by a credit card or electronic funds transfer. Preferably, the data processing system may be located on a mainframe which is capable of performing all batch processing which supports the system thought this could as well be provided by distributed processing on multiple networked computers.

As an overview, the applicant's invention is a system which simulates a form of artificial intelligence utilizing the processing system to determine whether an applicant can be insured online, and if so, derives the premium and binds the policy, in an automatic fashion. The user inputs all relevant information based on their personal information and as the information is read by the data processing system, the system in an automated fashion begins the process of retrieving data from databases associated with the input data, such as obtaining a credit report, claims history, and motor vehicle report for the individual(s) named on the policy application. This data is collected and stored possibly in the server database or mainframe database or may be stored in another location. The application software includes an underwriting algorithm that analyzes the data after verification and utilizing the underwriting algorithm in comparison to a set of business rules, renders a determination as to whether the applicant is qualified to receive a binding policy online. An important component of the system is that it undertakes an automated intelligent process of retrieving credit information, claims history information, and motor vehicle reports for each and every individual sought to be included on the policy in real time so as to allow the underwriting algorithm to be applied to determine the insurability of the applicant. The application software then evaluates risk and determines whether or not the person may be insured automatically as well as the premium associated with that risk evaluation.

This evaluation can be made in real time by comparison to data tables incorporated in the database located on the mainframe system so that at various decision points there is a go/no go determination of insurability, with reference to specific cut-offs for insurability and premiums. For example, more than two violations in 3 months, may result in a rejection and halt the process while 3 violations in 4 years may not and the process would continue.

The system will operate via a user interface which in essence is a web site connection where the user will encounter various web pages requesting information first for determining whether they would like to receive a quote, and if so, they are prompted via further web pages, possibly with assistance from drop-down menus, to enter their name and address information as well as other information necessary for determining the type of policy which they are seeking. In one embodiment, once the address information is validated, the user is queried as to their claims and violations history, and vehicle information. This can be further facilitated by the use of various drop-down menus as to vehicle make and model so as to speed the process. Once the formation is completed, the user may activate a submit button to receive an estimated quote. The quote is generated as a non-binding offer subject to validation, so as to speed the quotation process. If the quote is believed satisfactory, and the user wishes to purchase a policy, the applicant is invited to active a purchase button to continue the process and thereby to enter into the binding procedure. Alternatively, the quote may be saved, so the user has an opportunity to consult other sources before returning to the site to actually purchase the policy. At that point, the user may recall their saved quote, retrieved using an established user name and password.

To enter the binding process, the user must enter a social security number and once entered, the application software activates the interface communication links so as to link to the various databases necessary for obtaining and collecting credit information, motor vehicle and claims reports and other related information as needed, so as to validate the information previously submitted by the applicant and complete the analysis of insurability.

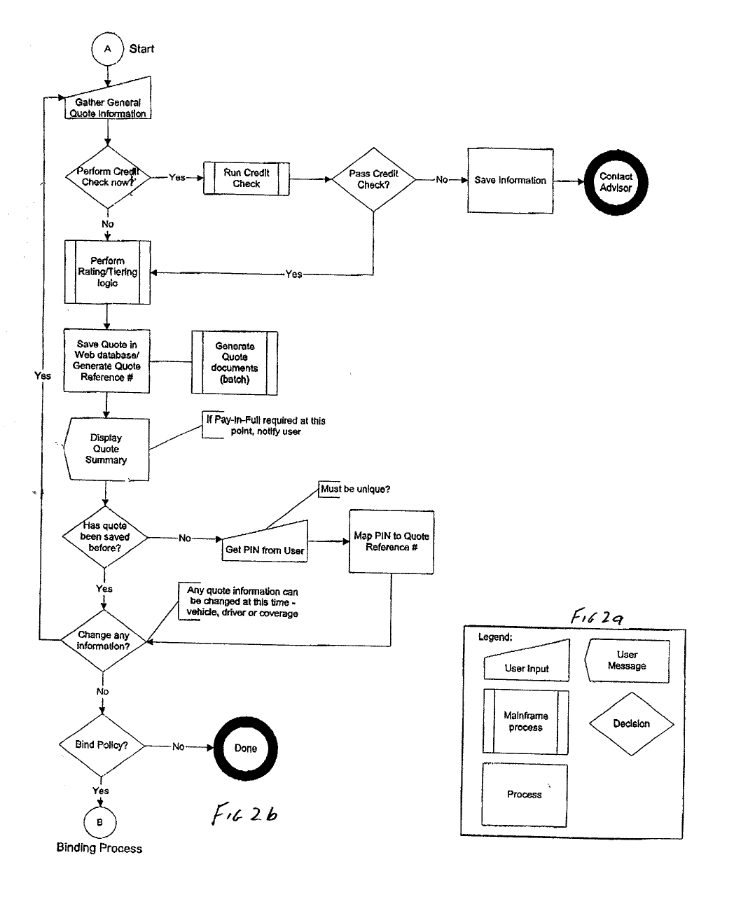

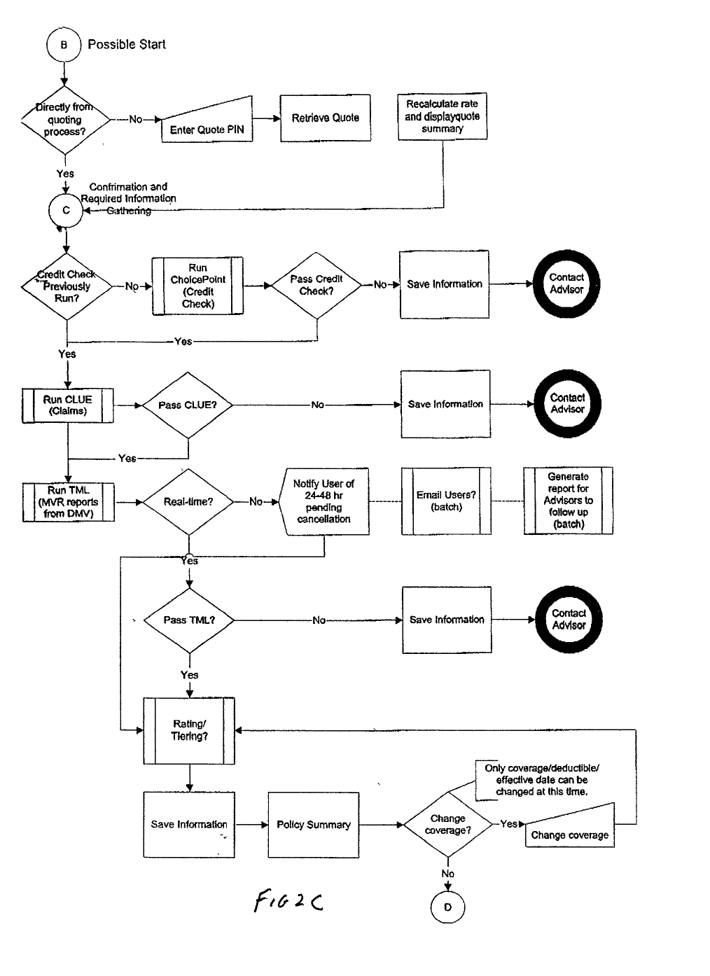

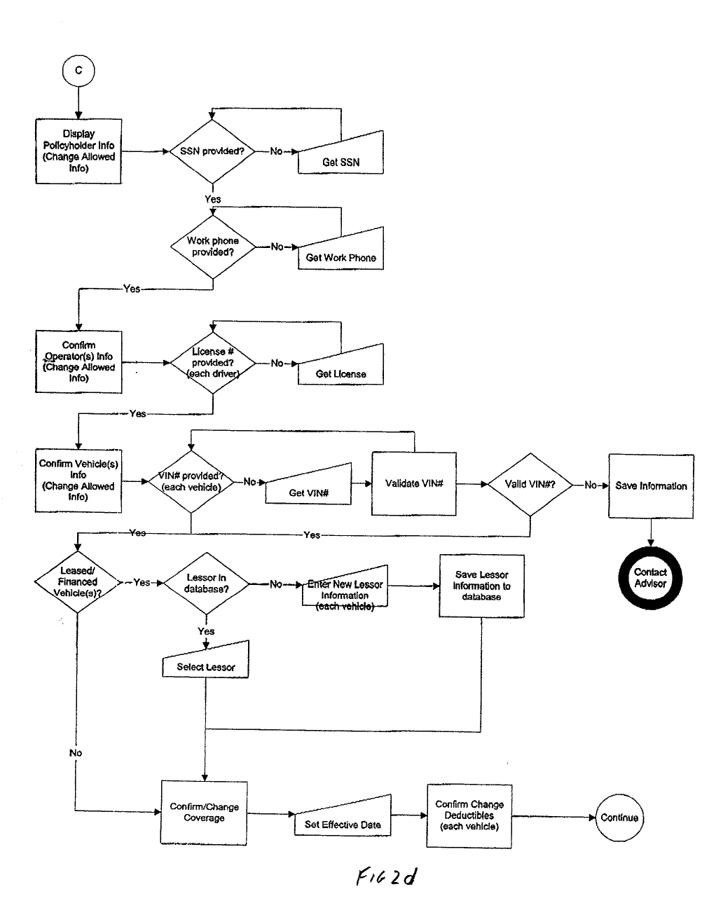

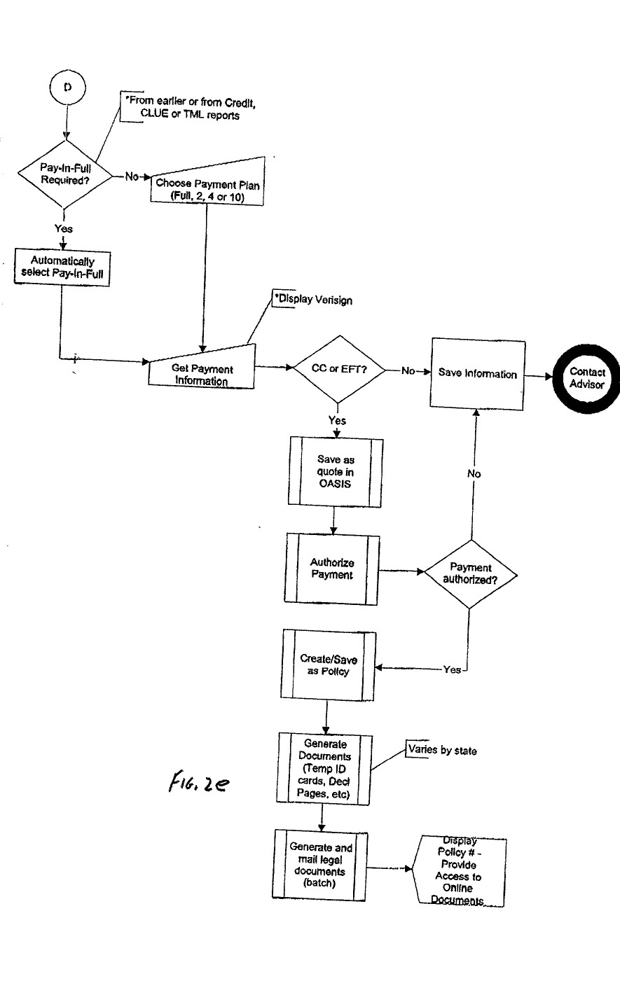

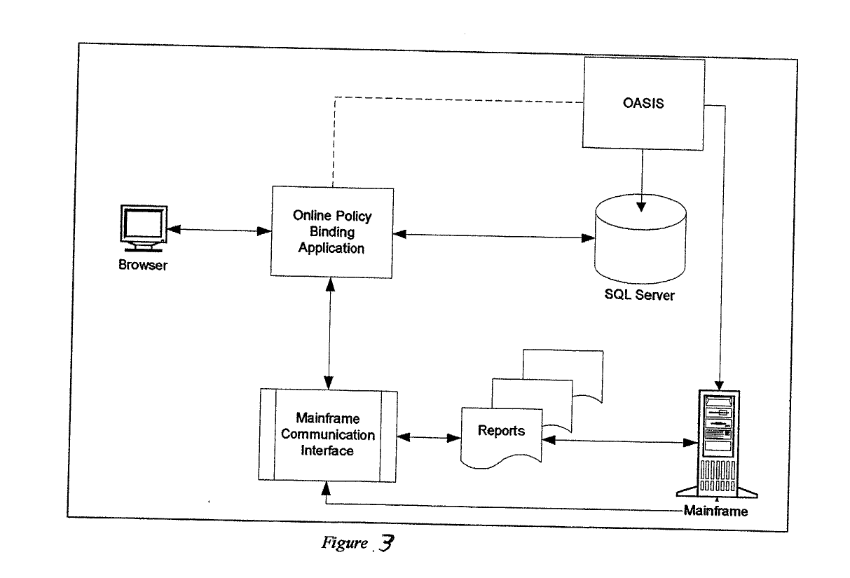

The enclosed FIG. 2 shows the functional flow diagram indicating a preferred sequence in which the processing steps will be taken. In essence, the data after validation and supplemental collection from the queried databases is utilized by the application software to determine whether to bind the user on-line or refer them to a call center where further questions and/or information may be required prior to issuing the policy. If the algorithm is run and there

are no discrepancies in the information provided, and the user meets the business rules as applied to the information collected, the user will be automatically qualified and be entitled to purchase a policy. The user then is presented with payment options, and may choose a full or partial payment plan and select a method of payment. The user will have the option to electronically pay for the policy via credit card or electronic funds transfer and if paid online, the policy forms may be electronically sent to the user. For example, should the user specify payment via credit card and the payment is authorized by the credit card issuer, the user may then immediately generate selected insurance documents for downloading or printing at the local terminal. These may include for example, temporary insurance identification cards, a policy summary etc. The data processing system will simultaneously automatically generate any other legal documents associated with the policy for mailing to the user to confirm the on-line transaction.

Utilizing the present invention, the user may obtain a policy on line in real-time, without the significant delays normally associated with dealing with agents who have to collect separately the validation information, send it to underwriting, etc. all done in a substantially manual fashion. As the system is automated, human intervention is only required when the user enters parameters which raise questions concerning insurability and/or discrepancies arise between the information provided and that retrieved from the various databases in communication with the system. Even in that instance, the data processing system having completed the primary analysis and data collection, automatically provides a report such that the contacted representative has available immediately the complete assessment as well as an indication of the open issues that need to be addressed, thus avoiding further delay when discussing the policy with the user.

Thus a method for binding insurance policies via a computer network is present, the network including a main computer having a memory and a data storage capability coupled via a communication interface to a plurality of databases, the method comprising the following steps performed by a data processing system i.e. computer, presenting an interactive display via a network to a user; accepting personal information from the user via the network; analyzing the information and presenting a quotation to the user for the insurance policy; accepting a request to issue a policy to the user; querying the user for information related to insurability via the interface, the information received stored on the data processing system; requesting information on insurability via a communication interface from selected databases related to the information provided by the user; analyzing the data and determining in reference to a set of business rules whether or not the user meets an acceptable insurability level relative to the policy sought and if so, generating a response that accepts the users' request for a policy; and, upon an indication that payment will be submitted, thereafter binding and issuing the insurance policy to the user.

In a preferred embodiment, the computer processing system also determines, relative to degree of insurability, a premium for payment by the user and if accepted, the data processing system further has means to accept payment by credit card and/or by electronic funds transfer, so as to enable instantaneous binding of the user upon receipt of payment. At that point, the user may be provided online with specific documents associated with the policy, such as a temporary ID card so that the user may benefit immediate from the ability to bind the policy online.

Alternatively, if the user fails to meet the insurability requirements and/or submits data that is necessary to form performing analysis, the data processing system automatically routes the user to a call center where any further questions can be asked and clarification made of the parameters that caused rejection of the application. However, as all the information provided by the user is available to the person who is manning the call center, the person will have immediate access to the information that has been provided to date and know with specificity what deficiencies there are in the application that need to be addressed. Consequently, the system incorporates means for initiating contact with the call center and for providing information to persons manning the call center so as to facilitate issuance of the insurance policy.

The system is more fully described in the accompanying on-line policy binding functional specification associated web pages which illustrate the pages which will be viewed by the user and the logic diagram which shows the functional flow likely to occur.

TABLE 1
Terms and Definitions

| Term | Definition |
|---|---|
| OASIS | COBOL application that is used by the call center to quote, |
| | manage and maintain auto insurance policies and accounts. |
| IQuote | Web application that allows any user to obtain a free rate quote |
| | for automoblie insurance. |
| RTS | A supporting application service that allows the IQuote web |
| | application to establish a connection to and access exiting |
| | logic in the OASIS application. |
| MVR | Motor Vehicle Reports |
| TML | External service that provides real-time MVRs. |
| CLUE | Comprehensive Loss Underwriting Exchange. Report that |
| | provides real-time claims reports. |
| EFT | Electronic Funds Transfer |
| Advisor | Knowledgeable call center operator who uses the OASIS |
| | application. |
| ACD | Codes used on real-time MVRs that represent violations. |
| Host | The mainframe computer. |
| DNQ | (Does Not Qualify)—refusal to quote a potential customer. |
| PAD | Possible Additional Driver—term used on a CLUE report to |
| | identify possible unreported drivers in a household, |
| PRC | Possible Related Claim—type of claim listed on a CLUE report. |

Anyone with a compatible browser and an Internet connection is a potential user of the system, as he online binding system will be integrated into a web site and work in conjunction with a quoting portion of the web site. Users may not bind a policy without first having been through the quoting process.

The online binding application is a web application that provides a user interface and all functionality necessary to enable an applicant to bind a policy online. Business logic that comprises the binding process is contained within the application or is accessed from an external source (such as OASIS or the mainframe) by the application. The COBOL OASIS application will be utilized by advisors in a call center. OASIS may additionally access the mainframe through a separate interface program.

Information collected from the quoting process is collected and stored in a SQL Server database. The SQL Server also maintains additional data that is required to support both the quoting and binding processes. Information such as Account Master, Bill Plan, State Master, Thompson data and leasing company information is maintained in the SQL Server database. All communication with the host from the web environment will be accomplished through an interface program. Access to the host is required for obtaining MVRs, CLUE reports and credit scores. Payment processing (credit card and EFT) and policy creation, as well as policy document generation, require communication with the mainframe.

The mainframe maintains the core of the business data. All batch processing that supports the system (as well as other systems) is performed on the host.

A social security number (SSN) is required to perform a credit check. Users will have the option of providing a SSN early in the quoting process. If provided, a SSN allows a credit score to be obtained for the individual, which can then be used to identify an ‘at-risk’ customer. If a user's credit score is not above a given score, then any provided information is stored in the database and the user is instructed to contact an advisor.

Credit scores are obtained from an external vendor such as ChoicePoint, which uses its own algorithm to validate the provided name with the SSN—no further verification is necessary. Customers who do not disclose a SSN will still be allowed to continue with the quoting process, but a SSN will be needed before binding can be completed. The user will be required to enter the SSN twice to ensure validity and accuracy. This may be accomplished through a pop-up box.

If the user provides a SSN and no credit score is obtained from the supplied information, a credit score of zero (0) will be used. In some states, such as California, a credit check may not be done, and in such a case, users will not need to enter their SSN. If the user does not supply a SSN in order to run a credit score, a default credit score of six-hundred (600) is used.

The ‘Date First Licensed’ needs to be obtained in the quoting process. This information is a required field during quoting. The information supplied by the user is later verified against the MVR. States are grouped into three categories:

States that list probationary date licensed

States that list renewal date licensed

California

For states that list probationary date licensed, the user is queried—“Have you been licensed for at least five (5) years?” If the user answers NO, he/she will be required to answer the following question—“What year were you licensed?”

For states that list renewal date licensed—(same as above for states with probationary date licensed).

For CA, the query would be—“How old were you when you received your license?”

Users who complete a quote (or who save a quote prior to completion) are given a quote reference number that can be used to access the quote at a later time. The system will give users the opportunity to choose a user name and a password that will be used when recalling a quote. These passwords can be used to allow customers access to their accounts.

Once a quote has been processed and a premium has been generated, the customer would be able to modify any quote information, not just coverage and deductibles. Providing this feature allows the user to simulated ‘What-If’ scenarios during the quoting process rather than in the binding process.

The last page in the quoting process displays the user's current coverage and deductible selections (or the defaults if the user has not selected any). As an enhancement, this last page may display a declaration summary page, including coverage, deductibles and a quote summary.

From the summary page, the user is allowed to return to the coverage and deductible assignments in order to recalculate a premium. Users who wish to bind a policy online must have completed the quoting process. Binding can be performed immediately after quoting, or it can be done at a later date. If binding is not done at the same time as quoting, the user's previously created quote must be recalled, using the username and password that were chosen earlier to recall the existing quote.

Upon recalling a quote and entering the binding process, the user is directed to a quote summary page. The quote is recalculated and the summary page is displayed. If the quote was saved prior to ever being rated at least once, the user will instead be directed back to the first page of the quoting process. The quote will be re-rated using the current date as the effective date. The quote summary page will not be displayed if the user is entering binding directly from the quoting process. When recalling a quote, an option is available to have the system provide the user with a hint, if a user forgets the password or the user will be instructed to contact the call center. Once a quote has been successfully recalled, a screen is displayed, informing the user that the SSN, VINs and other information will be required to complete the policy.

The process of binding online consists of confirming all the existing information that was provided for the corresponding quote, as well as providing additional, required information. Information that was provided during the quoting process is redisplayed to the user for confirmation, and any additional information is requested.

If changes need to be made to a quote during the binding process that are not allowed at this stage, the user will be returned to the corresponding quoting portion of the quotation process. All information is retained but the user will be required to sequentially complete the quote from the quote page to which he/she was redirected. Once the quote is complete the user will begin the binding process over again from the beginning (all information that was previously entered will be retained).

Personal information is redisplayed to the user for confirmation. Additional fields that were not required during the quoting process are necessary for completing a valid policy. The user will be required to enter the SSN twice to ensure validation and accuracy, unless the use has already provided a SSN. If the applicant has been at the current address for less than five (5) years, then the user should provide up to two additional addresses (maximum of three (3)—current plus two (2) additional). These addresses are used when submitting a request for a CLUE report.

An Operator Information screen displays data about the vehicle operator(s) that was captured in the quoting process. Up to four operators can be specified on a policy. Users wishing to include more than four operators on a policy need to contact an Advisor in order to complete policy binding.

Data about each vehicle listed on the policy must be gathered. During the binding process, the vehicle information is redisplayed for confirmation from the user. At this point the user can change any information, as well as add or remove vehicles from the policy. The vehicle screen(s) capture the operator assignments. Default operators will be recommended but may be changed by the user. No more than four vehicles can be included in an online policy, and required fields must be provided before the user can proceed.

If the VIN provided by the user does not match the make, model and submodel selections made in the quoting process, the user will be prompted to re-enter the VIN. If a discrepancy still exists, the appropriate vehicle model, submodel and discount information will be overwritten based on the VIN lookup and the user will be notified.

Default operator assignments will be determined by the system. The user has the option of changing the operator assignments. If any vehicle has a garaging location zip code that is different from the policyholder's zip code, then the user will be instructed to contact the call center.

If a vehicle is leased or financed, then additional information is required about he leasing company. The user is able to choose the lending institution from a drop-down list. If the user's lending institution is not available, then the user can add a new financial institution by providing the necessary information. The information entered by the user is then stored in the database.

Coverage information from the quoting process is displayed to the user for confirmation during the binding process. At this time, the applicant may choose to change his/her coverage. Coverage that is available varies by state. Stacking coverage is mandated by individual states as well. All state specific information is stored in a LIMITS file (what coverages are available for each state, the coverage amounts for the available limits, etc.). This file only contains coverage and limit information for the basic ten coverages (BI, PD, MED, PIP, UMBI, COMP, COLL, TOW, RENT, UMPD). Information about which states allow stacked coverage (and what coverage it is allowed on) may be stored in a file or database (hard-coded).

Deductibles assigned in the quoting process are displayed to the user for confirmation during the binding process At this time the applicant may choose to change his/her deductible information. Deductible amounts are configurable for each vehicle listed on the policy. Default coverage is assigned to any new vehicle added to the policy.

The available deductible amounts will vary by state. All state specific information is stored in a LIMITS file (deductibles are available for each state, the deductible amounts for the available deductibles, etc.). Additional deductible limits are not stored in the LIMITS file and are hard-coded.

Once the applicant has provided all of the information for the policy and has assigned coverage and deductible information, the Start Date of the policy must be set. The Start Date must be at least 24 hours from the time of binding but no greater than sixty (60) days from the current date. If the current time is 12:00 p.m. (noon) or earlier, then the minimum Start Date is the current date plus one (1) day. If the current time is after 12:00 p.m. (noon), then the minimum Start Date is the current date plus two (2) days. The End Date is always one year from the chosen Start Date and is not editable by the user.

If the user provided a SSN during the quoting process, a credit score was already obtained. If a SSN was not provided during the quoting process, then it was obtained during the binding process and will be used to obtain a credit score. The applicant's SSN, first name, last name and address are used to obtain a credit score. The credit score is obtained in real-time from an external vendor. A request is made to the mainframe and the mainframe communicates with the external vendor to retrieve the credit score. If the credit score does not meet the minimum score requirements, then the user's policy information is saved to the database and the user is prompted to contact an Advisor for further assistance.

In the quoting process, if the user indicates that more than one accident or claim has been filed in the past five (5) years, the user will be required to provide detailed information about each claim. This information is saved and used later for validation against a CLUE report. All required information must be provided for each claim that the user indicates. The Driver for each claim must be one of the drivers on the quote. The accident description must be one of the predetermined descriptions.

Available Accident Descriptions:

Applicant's vehicle hit other vehicle

Applicant's vehicle hit tree, pole, parked car or other fixed object

Applicant's vehicle hit pedestrian or bicyclist

Applicant's vehicle hit by other vehicle

Applicant's vehicle was hit while parked

Applicant's vehicle was vandalized or stolen

Applicant's vehicle hit animal

Applicant's vehicle was damaged by hail, snow, rain, etc.

At-Fault Accident (Generic)

Not-At-Fault Accident (Generic)

All claims are reported during the quoting process. The binding process will only verify information that was entered during the quoting process. To make any changes to the claims, the user must return to the quoting process.

To accurately create an automobile insurance policy, a background check of the applicant's insurance claims must be performed. These CLUE reports are obtained from an external vendor and detail a given applicant's comprehensive losses and insurance claims. From the web environment, a call is made to the mainframe, which in turn communicates with an external vendor to receive a CLUE report in real-time. A decision about a potential policyholder's risk can be made after examining a CLUE report. If the CLUE report does not meet the criteria set forth by the business, any information that has been provided is saved to the database, and the user is prompted to contact an Advisor.

A single CLUE report is run for the entire policy. All addresses that the named insured has lived at in the past five (5) years need to be collected and used for obtaining the CLUE report, with a maximum of three addresses allowed [current plus two (2)].

Detailed information is required for each violation that the user indicated early in the process. The number of violations is required for each driver that is to be included in the insurance policy. All required information must be provided for each violation that the user disclosed. The Driver for each violation must be one to the drivers on the quote. The violation description must be one of the predetermined descriptions.

Available Violation Descriptions:

Speeding 1-15 MPH over the posted limit

Speeding 16-29 MPH over the posted limit

Speeding 30+ MPH over the posted limit

Failure to stop

Failure to fasten seat belt

Driving under the influence/Driving while impaired

Other

All violations are reported during the quoting process. The binding process will only verify information that was entered during the quoting process. To make any changes to the violations, the user must return to the quoting process.

Similar to the CLUE reports, MVR reports are obtained from external vendors that detail a user's motor vehicle violations. These reports are used to determine the potential risk of an applicant. States fall into one of two categories: real-time MVR or batched MVR.

Several states provide access to real-time MVRs. The reports are available immediately for perusal by the policy binding application. The web environment calls the host which in turn contacts an external vendor (TML) to obtain an MVR for a given license number. If an applicant does not meet the criteria set forth by the business, the applicant's information is stored in the database and the applicant is prompted to contact an Advisor for further assistance.

States with batched MVRs will not be allowed to bind online initially. Users from a batched state should be notified prior to the binding process that they must call an Advisor if they wish to bind a policy. All operators on a policy need to be checked. If any of the additional drivers on the policy have a license from a batched state, the policy will not be able to be bound online. Some states do not support access to real-time MVRs. These states receive requests and then process a batch of requests rather than one request at a time. ChoicePoint is the external vendor that provides the batched MVR results. If states with batched MVRs are supported in the online environment, the applicant's from these states must be notified that their policy binding is pending the MVR results.

The rating and tiering logic uses all pertinent information supplied by the applicant to calculate a premium for the policy. Certain conditions that are handled in the rating process may required the premium payment to be paid in full. Individual amounts for each coverage and deductible option chose are returned for the rating/tiering calculation.

Upon completion of the rating and tiering process a policy summary is displayed to the user. The user can accept the terms of the policy and proceed to payment, or the user may modify the policy coverage limits, deductible amount or the Start Date. Any changes will require the policy to be processed by the rating and tiering engine, which then displays a new summary page.

Payment information must be selected and processed in order to complete the binding process. Different payment plans are available on a state-by-state basis. If applicants are not required to pay in full they may choose the preferred payment plan. Each payment plan will show the proper installation payment amount (returned from the rating/tiering logic). A payment plan must be selected. The initial payment amount text box is automatically pre-filled when a payment plan is chosen by the user.

Policy payment is completed by selecting a payment method and supplying the required information for that payment method. Only two payment methods will be available online:

Credit Card (Master Card, Visa or Discover Card, etc.)

Electronic Funds Transfer (EFT)

At this point, the information entered by the applicant exists only in the web SQL database, not on OASIS. Three steps are required to turn the information collected into an actual policy in OASIS. First, once all information have been processed and verified, it is sent to the host to be saved as a quote in OASIS. Second, the appropriate external vendor then processes the payment for authorization. Third, upon payment authorization, the host creates and saves a policy in OASIS.

The policy number is returned to the user. A policy will not be created if payment is not authorized. All information is sent to the host to create the policy. Policy numbers are generated by the mainframe and will use the existing algorithm for generating policy numbers.

Once the policy has been bound online and created on the host, policy documentation needs to be made available to the new policyholder. Existing process on the host will send the information to the composition server, which will generate all of the proper documentation to be sent via postal mail. A separate request from the web environment will cause certain documents to be generated in PDF format and stored in a temporary directory. These will be made available to the online user (via email).

Users will be able to choose which documents they wish to be made available immediately. These include:

Temporary ID cards

Declaration pages

Loss Payee/Additional Insured Letters

CARCO Inspection form

These documents may be provided in a PDF format. A link to the Adobe Acrobat web site can be made available from the online binding site in order to download the free Acrobat Reader™ for users who do not have this software. (Acrobat Reader™ is required to read documents with the PDF extension.) A list of all documents that will be sent to the user via postal mail, and which forms are required to be completed and returned, will be displayed to the user.

Temporary ID cards are available for download by the insured. Additional documents may be made available online, such as:

Cancellation Letters to predecessor carriers

Driver Exclusion (CA only)

Driver Fitness form

UM Waivers

EFT Authorization

Seat Belt Pledge

GA Good Student form

The user may choose the method for obtaining the requested online documents. Options include:

Email documents to user

Immediate download (warn user of time for download)

Fax documents through FaxQuote

While preferred embodiments of the present invention have been shown and described it will be understood by those skilled in the art that various changes or modifications could be made without varying from the scope of the present invention.

What is claimed is:

1. A method for on-line binding of insurance policies comprising:
providing a data-processing system having means to communicate and query a plurality of databases;
providing a user-interface accessible via the Internet, the interface connected to the data processing system;
querying a user who is seeking an insurance policy for information related to insurability via the user-interface, the information received by the data processing system;
analyzing and issuing queries from the data processing system to select databases for verification and supplementation of the user supplied information, and retrieving information therefrom;
comparing the user information to the retrieved information from the databases, weighing the information as to risk and determining whether the user is qualified to be insured;
advising the user if the user is accepted, and if accepted, presenting an input interface for allowing the user to agree to accept a policy and generating a binding insurance agreement, and if not accepted, advising the user to contact a representative for further inquiry.

2. The method of claim 1 further comprising, after generating the binding insurance agreement, presenting a list of insurance related documents available for downloading or printing by the user.

3. The method of claim 2 wherein the insurance related documents include the insurance policy and insurance identification cards.

4. The method of claim 1 further comprising collecting credit information from the user, obtaining credit information from the select databases, generating via the data processing system a premium based on the analysis of insurability, and displaying the premium to the user.

5. The method of claim 4 further comprising providing means for the user to pay the premium or a portion thereof on-line.

6. The method of claim 1 wherein the select databases contain data selected from the group consisting of motor vehicle reports, comprehensive loss underwriting exchange reports, credit reports, title records, and violations.

7. The method of claim 1 wherein, if the user is not accepted, generating a report containing the collected information and transferring the report to a representative for follow-up with the user by the representative.

8. The method of claim 1 further comprising collecting and analyzing data on each person identified for inclusion on a single policy and analyzing each person for insurability, prior to determining the acceptability of the user.
